(19) United States
(12) Patent Application Publication
(10) Pub. No.: US 2004/0225796 A1
(43) Pub. Date: Nov. 11, 2004

(54) Expandable miniature accessory card for handheld computer

(75) Inventors: William Robert Hanson, Mountain View, CA (US); Yoon Kean Wong, Menlo Park, CA (US)

Correspondence Address: FOLEY & LARDNER, 777 EAST WISCONSIN AVENUE, SUITE 3800, MILWAUKEE, WI, 53202-5308, US

(73) Assignee: Palm, Inc.

(21) Appl. No.: 09/821,522

(22) Filed: Mar. 29, 2001

(51) Int. Cl. G06F 13/00

(52) U.S. Cl. 710/301

(57) ABSTRACT

An expansion device for a handheld computer is disclosed. The expansion device includes a Secure Digital input/output (SDIO) card including an interface configured to be coupled to the handheld computer. The expansion device also includes an accessory device coupled to the SDIO card. Further, the expansion device includes an expansion slot coupled to the SDIO card. The expansion slot is configured to selectively couple to one of a Secure Digital (SD) card and a multimedia card (MMC).

### FIELD OF THE INVENTION

The present specification relates to accessory devices for portable electronic devices such as, but not limited to, handheld computers. In particular, the present specification relates to a Secure Digital input/output (SDIO) card for interfacing with a handheld computer. The SDIO card includes an expansion slot configured to accept either a Secure Digital (SD) card or a multimedia card (MMC) especially of the memory type, or other expansion cards.

### BACKGROUND OF THE INVENTION

Handheld computing devices, palmtops, personal digital assistants (PDAs) or handheld computers typically weigh less than a pound and fit in a pocket. These handheld computers generally provide some combination of personal information management, database functions, word processing, and spreadsheets. Because of the small size and portability of handheld computers, strict adherence to hardware constraints, such as input device hardware constraints and accessory device hardware constraints, must be maintained. Further, it is desirable to include other accessories for the handheld computer to further its functionalities. Such accessory devices include memory devices, positioning devices, audio players, voice recorders, Bluetooth transceivers, digital cameras, tuners, network cards, pedometers, cellular telephone transceivers, and the like.

It is conventional to provide accessory devices that are couplable to an interface on the handheld computer. Because of the small size of handheld computers, the design of accessories and associated memory devices couplable to the handheld computer are often a size and ergonomic issue. Accordingly., it is known to provide expansion modules to handheld computers that include hardware for accessory devices. Most of these hardware devices include the need for memory. It is conventional to include memory such as multimedia card memory into the expansion modules. Often, however, it is desirable to use a variety of types of memory modules with an expansion module. Further, it is often desirable to utilize memory devices which have a relatively small size.

Accordingly, there is a need for an accessory device module which includes a slot or interface for additional media or memory cards, because the expansion slot or expansion interface on the handheld computer is being used for the accessory device. Further, there is a need for an accessory device which includes an additional slot which may be occupied by either a SD card, a MMC, or a battery pack.

The techniques herein below extend to those embodiments which fall within the scope of the appended claims, regardless of whether they accomplish one or more of the above-mentioned needs.

### SUMMARY OF THE INVENTION

An exemplary embodiment relates to an expansion device for a handheld computer. The expansion device includes a Secure Digital input/output (SDIO) card including an interface configured to be coupled to the handheld computer. The expansion device also includes an accessory device coupled to the SDIO card. Further, the expansion device includes an expansion slot coupled to the SDIO card. The expansion slot is configured to selectively couple to one of a Secure Digital (SD) card and a multimedia card (MMC).

Another exemplary embodiment relates to a handheld computer. The handheld computer includes a housing and a slot in the housing. The slot includes an electrical connector. The handheld computer also includes a Secure Digital input/output (SDIO) card including an interface coupled to the slot in the housing and coupled to the electrical connector. Further, the handheld computer includes an accessory device coupled to the SDIO card. Further still, the handheld computer includes an expansion slot coupled to the SDIO card. The expansion slot is configured to selectively couple to one of a Secure Digital (SD) card and a multimedia card (MMC).

Yet another exemplary embodiment relates to an expansion device for a portable electronic device. The expansion device includes a Secure Digital input/output (SDIO) card including an interface configured to be coupled to the electronic device. The expansion device also includes an accessory device coupled to the SDIO card. Further, the expansion device includes an expansion slot coupled to the SDIO card. The expansion slot is configured to selectively couple to one of a Secure Digital (SD) card and a multimedia card (MMC).

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a schematic planar view of a handheld computer having an accessory device attached thereto;

FIG. 2 is a rear exploded schematic perspective view of the accessory device, memory card, and handheld computer of FIG. 1;

FIG. 3 is a rear perspective schematic view of the handheld computer of FIG. 1 showing the accessory device with the memory card attached thereto;

FIG. 4 is a top view of the handheld computer of FIG. 1 showing the accessory device with memory card attached thereto; and

FIG. 5 is a side of the handheld computer of FIG. 1 showing the accessory device with memory card attached thereto.

### DETAILED DESCRIPTION OF EXEMPLARY EMBODIMENTS

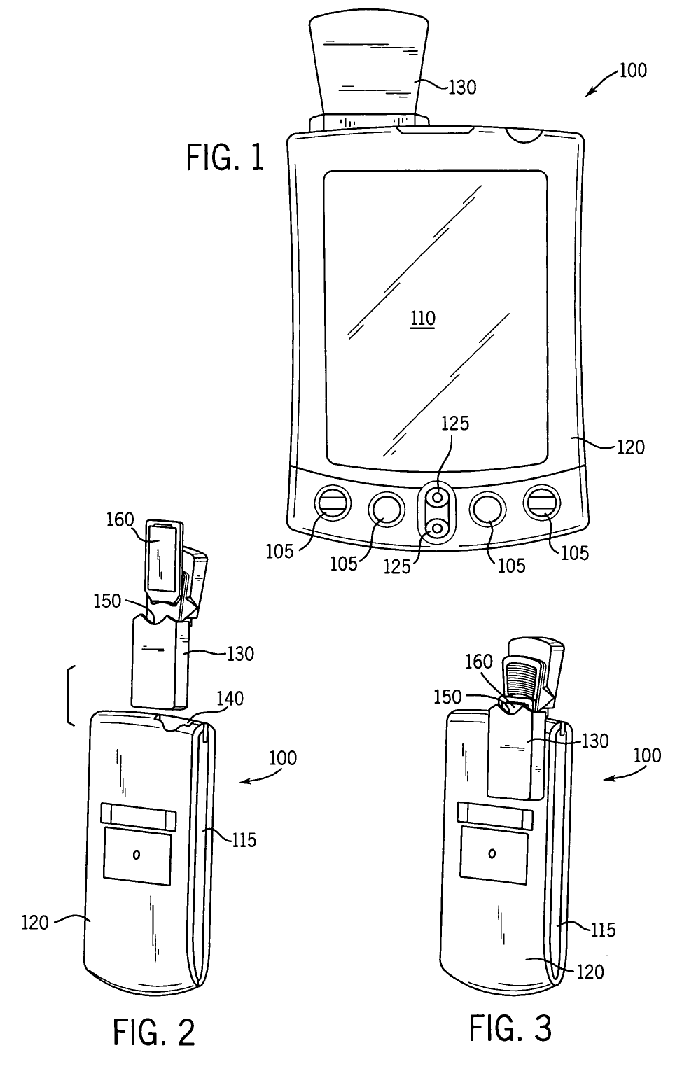

Referring to FIG. 1, a handheld computer 100 is depicted. Handheld computer 100 may include Palm™ style computers and other devices available from Palm, Inc., of Santa Clara, Calif. Other exemplary embodiments of the invention may include Windows CE handheld computers, or other handheld computers and personal digital assistants (PDAs), as well as mobile telephones, beepers, electronic books (e-books), and other mobile computing devices.

Preferably handheld computer 100 includes interactive hardware and software that performs functions such as maintaining calendars, phone lists, task lists, notepads, calculation applications, spreadsheets, games, and other applications capable of running on a computing device. Handheld computer 100, as depicted in FIG. 1, includes a plurality of input functions, keys 105 and a display 110 having graphical user interface features. Display 110 may be provided with an interface that allows a user to select and alter displayed content using a pointer, such as, but not limited to, a stylus which may be stowed in a slot 115 of housing 120 of handheld computer 100. (See FIGS. 2 and 3). In an exemplary embodiment, display 110 may also include a writing section which uses the Graffiti™ handwriting recognition software or other handwriting recognition software, for tracing alphanumeric characters as input. In an exemplary embodiment, display 113 is a touch screen display that is electronically responsive to movements of a stylus or other pointer (e.g., a finger) on the surface of display 110. Buttons 125 may also be used to provide a variety of programmed functions, including, but not limited to, display scrolling functions.

In an exemplary embodiment, handheld computer 100 includes an accessory device, depicted as Secure Digital input/output (SDIO) module 130 coupled to a primary expansion slot 140 in housing 120 of handheld computer 100. (See FIG. 2). In an exemplary embodiment, SDIO module 130 is based on the Secure Digital (SD) memory card which is a memory device approximately the size of a conventional postage stamp. SD memory cards generally are non-volatile memory cards which offer high-storage capacities in the range of 4 megabytes to 256 megabytes and possibly greater storage capacity. Further, SD memory cards offer relatively fast data transfer, flexibility and security characteristics. SD memory cards are configured to facilitate transfer and storage of digital files such as, but not limited to, document files, audio files, video files, graphic files, and the like. In an exemplary embodiment, SDIO module 130 is an SDIO card having an accessory device coupled therewith. For example, the accessory device may be, but is not limited to, a Bluetooth transceiver, a digital camera, an audio player, an FM or television tuner, a local area network (LAN) card, a global positioning system (GPS) receiver, a voice recorder, a pedometer, and other accessory devices.

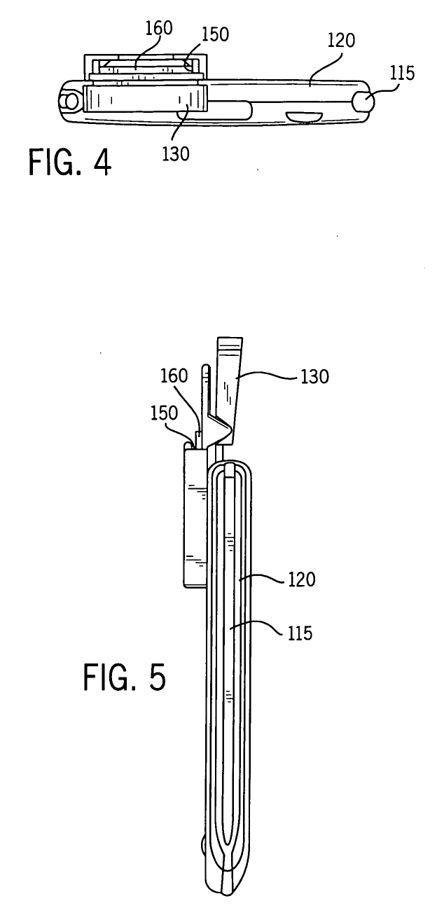

In an exemplary embodiment, primary expansion slot 140 includes an SDIO card connector. In operation, a user of handheld computer 110 couples accessory device 130 to slot 140 in housing 120 of handheld computer 100 by sliding the SDIO card connector into slot 140 where an electrical connection is made between a connector on the SDIO card and an SD connector of handheld computer 100. Referring now to FIG. 3-5, SDIO module 130 is depicted coupled to handheld computer 100.

In an exemplary embodiment, SDIO module 130 includes an additional expansion slot 150. Additional expansion slot 150 may be configured to accept and electronically couple to either of SD memory cards, MMC memory cards or any other types of flash memory cards. Further, because slot 150 is configured for SD cards, other SDIO cards having accessory devices may be coupled thereto as well. In a particular exemplary embodiment, slot 150 is configured to accommodate and couple to either SD memory cards or MMC memory cards, whichever a user may have available. For example, if SDIO module 130 was a MP3 player module, a user may wish to have portable access to a music collection, thus a large amount of memory would need to be incorporated into the MP3 module. However, incorporating such large amounts of memory into the MP3 player is undesirable because of cost and hardware constraints. Therefore, it is beneficial to have an MP3 player module that includes a slot 150 that is configured to accept interchangeable SD or MMC memory cards such that a music collection or other data stored on the memory cards is easily portable. In such a situation, a user of module 130 would be able to read music directly from SD or MMC memory cards on which music was stored previously.

Because SDIO module 130 includes expansion slot 150, extra memory is available to the SDIO device without increasing the cost of module 130 itself, as well as providing a means to download alternative content to a plurality of memory cards 160. Further, because only a finite amount of content or available memory space is available on SDIO module 130, having a removable media such as memory card 160 allows the user to pick and choose content to be used with SDIO module 130 in a relatively simple manner.

In an exemplary embodiment, an electrical connector, within expansion slot 150, is used having nine pins configured for use with SD memory cards. Because MMC cards utilize a seven-pin connector, expansion slot 150 is configured to accommodate the MMC cards and further is configured to use seven of the nine pins of the SD connector, thereby avoiding redundancy in electrical connections for the SD or MMC cards.

In a further exemplary embodiment, expansion slot 150 may be used to accommodate a battery pack, which may be a rechargeable battery pack for example. Such a battery pack may be used to supply power to an SDIO module accessory and/or may also be used as an auxiliary power source for handheld computer 100. Such a battery pack is configured to fit into slot 150 and further is configured to utilize any of the pins of the nine-pin SD connector within slot 150. The connector in expansion slot 150 further includes at least one pin configured to provide a power input to a battery pack during recharging of the battery pack.

In an exemplary embodiment, SDIO module 130 may be utilized as an expansion device for a variety of portable electronic devices, including, but not limited to, mobile telephones, notebook computers, palmtop computers, integrated automotive computers, and the like, without departing from the scope of the invention. Further, an SDIO module may be used for a variety of accessories including, but not limited to, positioning devices, such as global positioning system receivers; audio players, such as MPEG3 (MP3) players; beepers; voice recorders; Bluetooth transceivers, and other RF transceivers; digital cameras, and other types of cameras; tuners, such as frequency modulation (FM) tuners and television tuners; networking cards, such as home RF, Wi-Fi (IEEE 802.11), and LAN networking cards; pedometers, and other distance tracking devices; cellular telephone transceivers and pagers; as well as other accessory devices. Further, expansion slot 150 may be utilized for a variety of accessories including, but not limited to, MMC cards, SD cards, battery packs, and other accessory devices.

While the detailed drawings, specific examples, and particular formulations given describe exemplary embodiments, they serve the purpose of illustration only. The hardware and software configurations shown and described may differ depending on the chosen performance characteristics and physical characteristics of the computing devices. For example, the type of computing device, communications bus, or processor used may differ. The systems shown and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

1. An expansion device for a handheld computer, comprising:
a Secure Digital input/output (SDIO) card including an interface configured to be coupled to the handheld computer in a slot in a housing of the handheld computer;
an accessory device coupled to the SDIO card;
an expansion slot coupled to the SDIO card, the expansion slot configured to selectively couple to one of a Secure Digital (SD) card and a multimedia card (MMC) the slot configured to be located overlying a back side of the handheld computer.

2. The expansion device for a handheld computer of claim 1, wherein the SDIO card includes Secure Digital (SD) memory.

3. The expansion device for a handheld computer of claim 1, wherein the interface is configured to be coupled to a slot in a housing of the handheld computer.

4. The expansion device for a handheld computer of claim 1, wherein the accessory device includes a positioning system device.

5. The expansion device for a handheld computer of claim 4, wherein the positioning system device includes a global positioning system (GPS) receiver.

6. The expansion device for a handheld computer of claim 1, wherein the accessory device includes an audio player.

7. The expansion device for a handheld computer of claim 6, wherein the audio player is an MPEG3 (MP3) player.

8. The expansion device for a handheld computer of claim 1, wherein the accessory device includes a voice recorder.

9. The expansion device for a handheld computer of claim 1, wherein the accessory device includes a Bluetooth transceiver.

10. The expansion device for a handheld computer of claim 1, wherein the accessory device includes a digital camera.

11. The expansion device for a handheld computer of claim 1, wherein the accessory device includes a tuner.

12. The expansion device for a handheld computer of claim 11, wherein the tuner is a frequency modulation (FM) tuner.

13. The expansion device for a handheld computer of claim 11, wherein the tuner is a television tuner.

14. The expansion device for a handheld computer of claim 1, wherein the accessory device includes a networking card.

15. The expansion device for a handheld computer of claim 1, wherein the accessory device includes a wireless communications card.

16. The expansion device for a handheld computer of claim 1, wherein the accessory device includes a pedometer.

17. The expansion device for a handheld computer of claim 1, wherein the accessory device includes a cellular telephone transceiver.

18. The expansion device for a handheld computer of claim 1, wherein the expansion slot is configured to accept a MMC memory card.

19. The expansion device for a handheld computer of claim 1, wherein the expansion slot is configured to accept a SD memory card.

20. The expansion device for a handheld computer of claim 1, wherein both of a SD memory card and a MMC memory card may be used selectively and singularly in the expansion slot.

21. The expansion device for a handheld computer of claim 1, wherein the expansion slot is configured to accept a battery.

22. The expansion device for a handheld computer of claim 21, wherein the battery is rechargeable.

23. The expansion device for a handheld computer of claim 1, further comprising:
a second expansion slot coupled to the SDIO card, the second expansion slot configured to selectively couple to at least one of a Secure Digital (SD) card and a multimedia card (MMC).

24. A handheld computer comprising:
a housing;
a slot in the housing, the slot including an electrical connector;
a Secure Digital input/output (SDIO) card including an interface coupled to the slot in the housing and coupled to the electrical connector;
an accessory device coupled to the SDIO card;
an expansion slot coupled to the SDIO card the slot located overlying a back side of the housing, the expansion slot configured to selectively couple to one of a Secure Digital (SD) card and a multimedia card (MMC).

25. The handheld computer of claim 24, wherein the SDIO card includes Secure Digital (SD) memory.

26. The handheld computer of claim 24, wherein the interface is configured to be coupled to a slot in a housing of the handheld computer.

27. The handheld computer of claim 24, wherein the accessory device includes a positioning system device.

28. The handheld computer of claim 27, wherein the positioning system device includes a global positioning system (GPS) receiver.

29. The handheld computer of claim 24, wherein the accessory device includes an audio player.

30. The handheld computer of claim 29, wherein the audio player is an MPEG3 (MP3) player.

31. The handheld computer of claim 24, wherein the accessory device includes a voice recorder.

32. The handheld computer of claim 24, wherein the accessory device includes a Bluetooth transceiver.

33. The handheld computer of claim 24, wherein the accessory device includes a digital camera.

34. The handheld computer of claim 24, wherein the accessory device includes a tuner.

35. The handheld computer of claim 34, wherein the tuner is a frequency modulation (FM) tuner.

36. The handheld computer of claim 34, wherein the tuner is a television tuner.

37. The handheld computer of claim 24, wherein the accessory device includes a networking card.

38. The handheld computer of claim 24, wherein the accessory device includes a wireless networking card.

39. The handheld computer of claim 24, wherein the accessory device includes a pedometer.

40. The handheld computer of claim 24, wherein the accessory device includes a cellular telephone transceiver.

41. The handheld computer of claim 24, wherein the expansion slot is configured to accept a MMC memory card.

42. The handheld computer of claim 24, wherein the expansion slot is configured to accept a SD memory card.

43. The handheld computer of claim 24, wherein both of a SD memory card and a MMC memory card may be used selectively and singularly in the expansion slot.

44. The handheld computer of claim 24, wherein the expansion slot is configured to accept a battery.

45. The handheld computer of claim 44, wherein the battery is rechargeable.

46. The handheld computer of claim 24, further comprising:
a second expansion slot coupled to the SDIO card, the second expansion slot configured to selectively couple to at least one of a Secure Digital (SD) card and a multimedia card (MMC).

47. An expansion device for a portable electronic device, comprising:
a Secure Digital input/output (SDIO) card including an interface configured to be coupled to the electronic device;
an accessory device coupled to the SDIO card;
an expansion slot coupled to the SDIO card, the expansion slot configured to selectively couple to one of a Secure Digital (SD) card and a multimedia card (MMC).

48. The expansion device for a portable electronic device of claim 47, wherein the SDIO card includes Secure Digital (SD) memory.

49. The expansion device for a portable electronic device of claim 47, wherein the interface is configured to be coupled to a slot in a housing of the portable electronic device.

50. The expansion device for a portable electronic device of claim 47, wherein the accessory device includes a positioning system device.

51. The expansion device for a portable electronic device of claim 50, wherein the positioning system device includes a global positioning system (GPS) receiver.

52. The expansion device for a portable electronic device of claim 47, wherein the accessory device includes an audio player.

53. The expansion device for a portable electronic device of claim 52, wherein the accessory device includes an MPEG3 (MP3) player.

54. The expansion device for a portable electronic device of claim 47, wherein the accessory device includes a voice recorder.

55. The expansion device for a portable electronic device of claim 47, wherein the accessory device includes a Bluetooth transceiver.

56. The expansion device for a portable electronic device of claim 47 herein the accessory device includes a digital camera.

57. The expansion device for a portable electronic device of claim 47, wherein the accessory device includes a tuner.

58. The expansion device for a portable electronic device of claim 57, wherein the tuner is a frequency modulation (FM) tuner.

59. The expansion device for a portable electronic device of claim 57, wherein the tuner is a television tuner.

60. The expansion device for a portable electronic device of claim 47, wherein the accessory device includes a networking card.

61. The expansion device for a portable electronic device of claim 47, wherein the accessory device includes a pedometer.

62. The expansion device for a portable electronic device of claim 47, wherein the accessory device includes a cellular telephone transceiver.

63. The expansion device for a portable electronic device of claim 47, wherein the expansion slot is configured to accept a MMC memory card.

64. The expansion device for a portable electronic device of claim 47, wherein the expansion slot is configured to accept a SD memory card.

65. The expansion device for a portable electronic device of claim 47, wherein both of a SD memory card and a MMC memory card may be used selectively and singularly in the expansion slot.

66. The expansion device for a portable electronic device of claim 47, wherein the expansion slot is configured to accept a battery.

67. The expansion device for a portable electronic device of claim 66, wherein the battery is rechargeable.

68. The expansion device for a portable electronic device of claim 47, further comprising:
a second expansion slot coupled to the SDIO card, the second expansion slot configured to selectively couple to at least one of a Secure Digital (SD) card and a multimedia card (MMC).

69. The expansion device for a portable electronic device of claim 47, wherein the accessory device includes a wireless networking card.
